(19) United States
(12) Patent Application Publication
(10) Pub. No.: US 2018/0217233 A1
(43) Pub. Date: Aug. 2, 2018

(54) SYSTEMS AND METHODS FOR ESTIMATING OBJECTS USING DEEP LEARNING

(71) Applicant: Toyota Research Institute, Inc., Los Altos, CA (US)

(72) Inventor: Kuan-Hui Lee, Ann Arbor, MI (US)

(21) Appl. No.: 15/420,099

(22) Filed: Jan. 31, 2017

(51) Int. Cl. G01S 7/48; G06K 9/00; G06N 3/08

(52) U.S. Cl. CPC G01S 7/4802; G06N 3/08; G06K 9/00201

(57) ABSTRACT

System, methods, and other embodiments described herein relate to estimating an object from acquired data that is a partial observation of the object. In one embodiment, a method includes accessing, from a database, object data that is a three-dimensional representation of a known object. The method includes transforming the object data to produce partial data that is a partial representation of the known object with a relative fewer number of data points than the object data. The method includes training an observation model by using the partial data that is linked to the known object to represent relationships between the object data and the partial data that provide for estimating the known object from the obscured data of a partially observed object that is unknown.

### TECHNICAL FIELD

The subject matter described herein relates in general to systems for training an observation model using partial data of known objects and, more particularly, to estimating a body of an observed object from observation data that is at least partially obscured by using learned characteristics of objects embodied by the observation model.

### BACKGROUND

Identifying objects using electronic sensors can be a complex task. For example, a sensor may not obtain complete data of an object, which can cause complexities with identifying the object. In other words, under different environmental conditions and circumstances, the electronic sensors obtain obscured data that is an observation of an object at a reduced resolution (i.e., fewer overall data points) or of just a portion/section of the object (e.g., rear quarter of a vehicle). Consequently, a computing system may not be able to identify the object from the obscured data since a complete observation is not available. However, under certain conditions, partial observations may be the only available data about the particular object. Accordingly, when unobscured data is not available, difficulties can arise in relation to various tasks, such as object recognition and object tracking, that rely on a comprehensive placement and identification of objects in the surrounding environment.

For example, autonomous vehicles can use electronic sensors to observe a surrounding environment and to build an obstacle map of objects in the surrounding environment from observed data. In general, the autonomous vehicles can use the obstacle map to avoid objects within the environment when navigating. However, when an object is only partially observed and cannot be properly identified from the partial observation, a corresponding obstacle map includes only the partial observations. As a result, the autonomous vehicle may not be fully aware of obstacles in the surrounding environment and, thus, may not be able to adequately navigate the surrounding environment because of this lack of information.

### SUMMARY

An example of an observation system is presented herein that estimates objects according to partially obscured data of an object. In one embodiment, the observation system uses data of known objects to train a model to estimate one or more sections of a body of an object when partial observations are provided. For example, in one embodiment, the observation system transforms data of a known object into data that simulates a partial observation to, for example, populate a database with partial observations that are identified and correlated with known objects. For example, the system can remove data points from the data of the known objects by segmenting the data and/or reducing a resolution of the data.

Thereafter, the observation system uses the database of generated partial observations to train an observation model. Moreover, the generated observation model describes relationships between partial observations and known objects. Accordingly, the observation system subsequently uses the observation model to estimate missing portions of an object when acquired data is a partial observation of the object. In this way, the observation system improves recognition and tracking of objects when acquired data is not comprehensive/complete.

In one embodiment, an observation system of a vehicle is disclosed. The observation system includes one or more processors and a memory that is communicably coupled to the one or more processors. The memory stores a learning module that includes instructions that when executed by the one or more processors cause the one or more processors to electronically access, within a database, object data that is a three-dimensional representation of a known object. The learning module includes instructions to transform the object data to produce partial data that is a partial representation of the known object with a relatively fewer number of data points than the object data. The learning module includes instructions to train an observation model by using the partial data that is linked to the known object to represent relationships between the object data and the partial data that provide for estimating the known object from data of a partially observed object that is unknown.

In one embodiment, a non-transitory computer-readable medium is disclosed. The computer-readable medium stores instructions that when executed by one or more processors cause the one or more processors to perform the disclosed functions. The instructions include instructions to receive, from a sensor, observed data that is a partial observation of an observed object. The observed data is missing one or more sections of a body of the observed object. The instructions include instructions to estimate the observed object by interpolating the one or more missing sections of the body of the observed object according to the observation model and the observed data.

In one embodiment, a method of estimating objects from obscured data of a partial observation is disclosed. The method includes accessing, from a database, object data that is a three-dimensional representation of a known object. The method includes transforming the object data to produce partial data that is a partial representation of the known object with a relatively fewer number of data points than the object data. The method includes training an observation model by using the partial data that is linked to the known object to represent relationships between the object data and the partial data that provide for estimating the known object from the obscured data of a partially observed object that is unknown.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an observation system that is associated with generating an observation model from partial observation data.

FIG. 3 illustrates one embodiment of a method that is associated with generating an observation model using partial observations of known objects.

FIG. 4 illustrates one embodiment of a method that is associated with estimating objects from obscured data.

FIG. 5A illustrates one example of a model of a vehicle.

FIG. 5B illustrates a partial observation of the vehicle from FIG. 5A.

FIG. 6A illustrates an example of a three-dimensional point cloud.

FIG. 6B illustrates an example of a transformed version of the point cloud of FIG. 6A that is artificially generated.

### DETAILED DESCRIPTION

Systems, methods and other embodiments associated with generating a model for estimating objects from partial observations of the objects are disclosed herein. As mentioned in the background, a vehicle operating in an autonomous mode uses electronic sensors (e.g., LIDAR sensors) to detect objects in an environment around the vehicle so that the objects can be, for example, identified and/or tracked. However, because of various circumstances (e.g., moving objects) and/or environmental conditions (e.g., weather), the electronic sensors may not always acquire clear and complete observations of objects. Consequently, a resulting representation of the objects may be inaccurate or may otherwise be incomplete since the available data is a partial observation of the object. Therefore, the autonomous vehicle can encounter difficulties when navigating through an environment for which a complete representation of objects for an obstacle mapping is not available.

Thus, in one embodiment, the observation system uses partial observations (e.g., segments/sections or reduced clarity observations) of known objects to train an observation model. As a result, the observation model embodies relationships between the known objects and the partial observations. Accordingly, when a partial observation of an unknown object is acquired, the observation system can estimate the unknown object by using the observation model to approximately interpolate a form/body of the unknown object. In this way, the observation system can improve identification and tracking of objects when a comprehensive observation is not available.

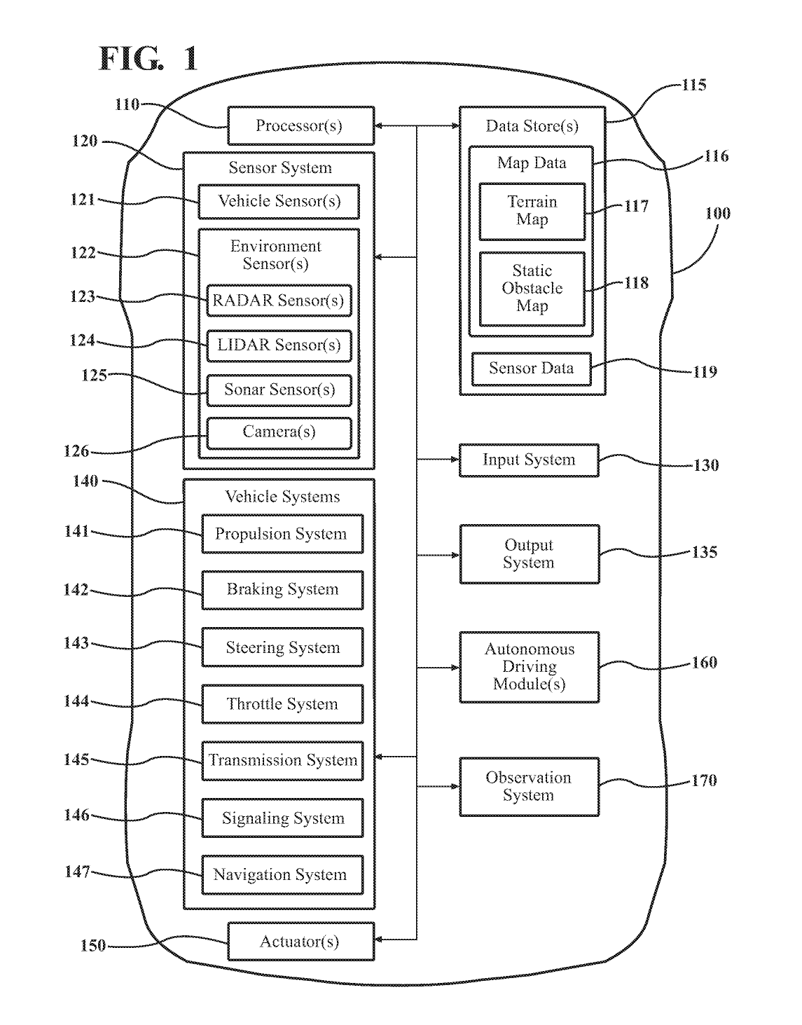

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any other form of motorized transport that benefits from estimating objects according to data that embodies partial observations of those objects.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. Further, while the various elements are shown as being located within the vehicle 100 in FIG. 1, it will be understood that one or more of these elements can be located external to the vehicle 100. Further, the elements shown may be physically separated by large distances.

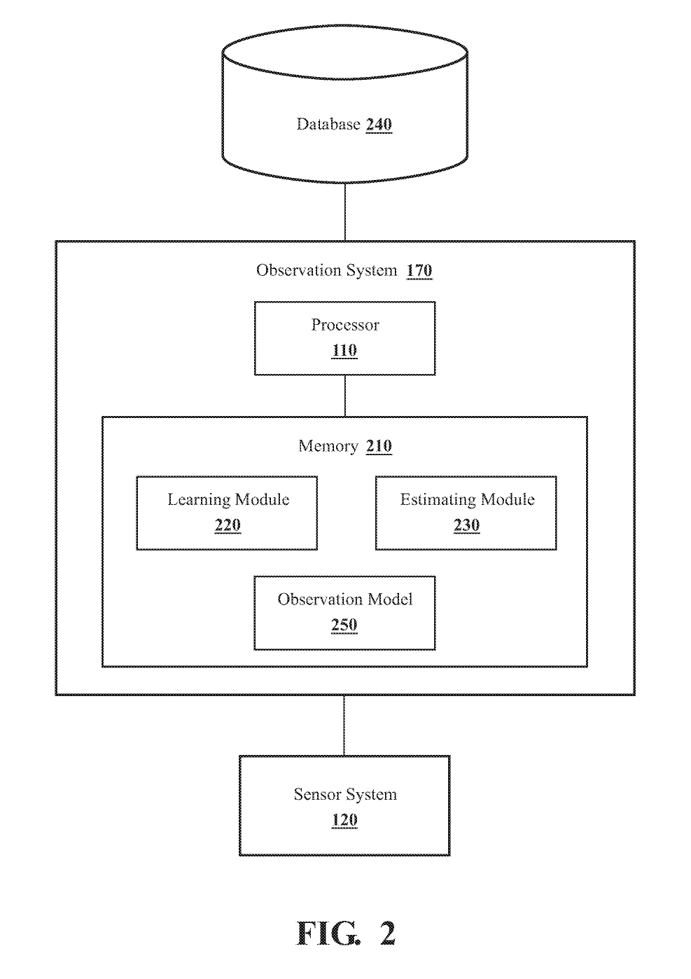

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the vehicle 100 includes an observation system 170 that is implemented to perform methods and other functions as disclosed herein relating to estimating an approximately complete form/body objects from obscured data that embodies, for example, a portion of the object and/or is of a reduced resolution such that the object is considered to be obscured or otherwise partially visible. Moreover, the observation system 170, in one embodiment, trains an observation model using transformed/deconstructed data of known/identified objects. For example, the system 170 uses a database of observational data that is of known objects (e.g., vehicles, animals, etc.). In one embodiment, the system 170 transforms the observational data of the known objects into partial data by cropping portions of the data, reducing a resolution of the data, segmenting the data, and so on. In either case, the observational data of the database is labeled to represent an object embodied within the observational data. Thus, the partial data inherits the labeling from the observational data.

Accordingly, in one embodiment, the system 170 applies machine learning/deep learning algorithm(s) to the partial data to produce an observation model that embodies the relationships between the partial data and the objects of the observational data. In this way, the observation model is used to improve identification/recognition and tracking of objects when obscured data is available. As an additional note, while the system 170 is illustrated as being fully embodied/implemented within the vehicle 100, in one embodiment, one or more functional aspects of the system 170 are implemented within one or more servers that are remote from the vehicle 100. For example, the discussed functionality of the system 170, in one embodiment, is implemented as a cloud-based service such as a Software as a Service (SaaS). Moreover, the system 170 may be distributed among a plurality of remote servers that perform processing to achieve the noted functions. The noted functions and methods will become more apparent with a further discussion of the figures.

With reference to FIG. 2, one embodiment of the observation system 170 of FIG. 1 is further illustrated. The observation system 170 is shown as including the processor 110 from the vehicle 100 of FIG. 1. Accordingly, the processor 110 may be a part of the observation system 170, the observation system 170 may include a separate processor from the processor 110 of the vehicle 100, or the observation system 170 may access the processor 110 through a data bus or another communication path. In one embodiment, the observation system 170 includes a memory 210 that stores a learning module 220, an estimating module 230, and, for example, an observation model 250. The memory 210 is a random-access memory (RAM), read-only memory (ROM), a hard-disk drive, a flash memory, a distributed memory, a cloud-based memory, or other suitable memory for storing the modules 220 and 230. The modules 220 and 230 are, for example, computer-readable instructions that when executed by the processor 110 cause the processor 110 to perform the various functions disclosed herein.

Accordingly, the estimating module 230 generally includes instructions that function to control the processor 110 to retrieve observational data from sensors (i.e., LIDAR sensor (s) 124) of the sensor system 120 and analyze the observational data to estimate objects in an environment surrounding the vehicle 100. In other words, the estimating module 230 includes instructions to estimate forms/shapes of bodies of objects (e.g., vehicles and other obstacles) that are currently surrounding the vehicle 100 when data obtained from the LIDAR 124 is at least partially incomplete (e.g., the observed object is partially obscured). Thus, as previously discussed, when the observational data is acquired some aspects of objects represented in the observational data may be obscured or otherwise unavailable such that the estimating module 230 cannot otherwise identify an observed object. This obscured data may result from a part of an object being obstructed by another object, from weather conditions degrading an ability of the sensors 120 to acquire observational data points of the object and so on. In any case, the obscured data is data acquired by one or more sensors from which identification of an object may be complicated because of missing data.

Thus, the estimating module 230 uses the observation model 250 that is stored in the memory 210 or alternatively in the database 240 to estimate objects from the observational data so that those objects can then be identified and/or tracked. The estimating module 230, in one embodiment, estimates missing sections of the observed object using interpolation techniques on the observed data and according to the observation model 250. The observation model 250 is generally discussed as being a model that embodies relationships between portions of the known object so that when obscured data is acquired, the object can be estimated/reconstructed from the obscured data. However, it should be understood that the observation model 250 is generally produced from or is part of a machine learning/deep learning network that is embodied as the learning module 220 and the observation model 250. For example, in one embodiment, the learning module 220 includes instructions to implement a neural network, a deep belief network, a Bayesian network, a Naïve Bayes classifier, or another form of machine/deep learning that is suitable for estimating objects according to the obscured observational data. Accordingly, the learning module 220 along with the observation model 250 embody a supervised learning algorithm, an unsupervised learning algorithm, a reinforcement learning algorithm, a deep learning algorithm, or another algorithmic-based learning approach.

In either case, in one embodiment, the learning module 220 includes instructions that function to control the processor 110 to electronically access data from the database 240 of known objects, transform the data into partial data that represents partial/obscured observations of the known objects, and train the observation model 250 according to the partial data. In this way, the resulting observation model 250 is trained to, in combination with the estimating module 230, estimate an object through, for example, interpolation when obscured data is acquired by a sensor, and an object is not otherwise identifiable. In other words, the observation model 250 is trained, such that, the observation model 250 includes learned characteristics of relationships between portions of objects.

With continued reference to the observation system 170, in one embodiment, the system 170 is communicably coupled to the database 240. The database 240 is, for example, an electronic data structure stored in the memory 210, a distributed memory, a cloud-based memory, or another data store and that is configured with routines that can be executed by the processor 110 or another processor for analyzing stored data, providing stored data, organizing stored data, and so on. Thus, in one embodiment, the database 240 stores data used by the modules 220 and 230 in executing various determinations. In one embodiment, the database 240 stores a library of three-dimensional point clouds acquired from previously observed objects which have been identified and labeled and are thus known. Accordingly, in one embodiment, the database 240 includes a library of models for known objects and/or generic types of objects (e.g., vehicles, signs, etc.). In general, the models stored in the database 240 are, for example, models that include data which is not obstructed or otherwise degraded. That is, the models of the known objects can be considered to be comprehensive observations of the objects.

However, in one embodiment, the database 240 can also include obscured observations of objects that have been subsequently identified. In either case, the models of the library are of identified objects and thus can be used by the learning module 220 to train the observation model 240. That is, the learning module 220 either transforms the models of the known objects into partial data or uses previously acquired partial/obscured observation data that has been identified to train the observation model 250. In either case, the partial data used by the learning module 220 is, for example, similar to what might be acquired by the LIDAR 124 when the vehicle 100 is operating under real-world circumstances. In this way, the learning module 220 can learn characteristics of how the partial data relates to a whole body of the known object and develop relationships between the partial data and the known objects in order to estimate the objects when a full observation is not available. Thus, the estimating module 230 can use the observation module 250 to interpolate missing sections of an object when provided with incomplete data in the form of a partial observation. In this way, the estimating module 230 can reconstruct a representation of the partially observed object so that the object can then be identified and/or tracked.

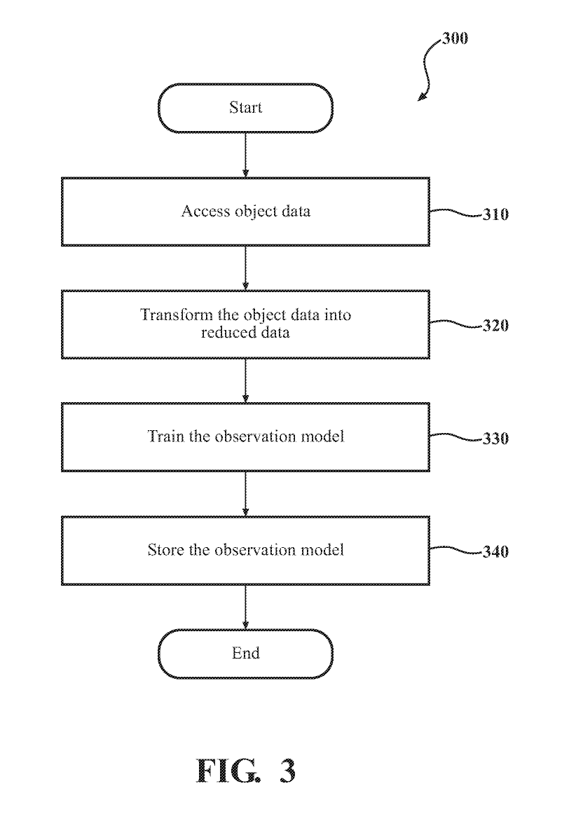

Additional aspects of training the observation model 250 will be discussed in relation to FIG. 3. FIG. 3 illustrates a method 300 associated with training an observation model 250 as a function of partial observations of an object. Method 300 will be discussed from the perspective of the observation system 170 of FIGS. 1 and 2. While method 300 is discussed in combination with the observation system 170, it should be appreciated that the method 300 is not limited to being implemented within the observation system 170, but is instead one example of a system that may implement the method 300.

At 310, the learning module 220 accesses object data. In one embodiment, the learning module 220 accesses the object data from the database 240. Alternatively, the learning module 220 can electronically access and/or retrieve the object data from a distributed memory, a cloud-based memory, or another suitable storage location. In either case, the object data includes one or more models (e.g., 3D point clouds) of previously classified/identified objects. The three-dimensional point clouds are, for example, models that represent objects from which the LIDAR 124 or another LIDAR sensor acquire data through observations (e.g., scanning using a light source). Moreover, the object data is generally understood to be identified and labeled so that the learning module 220 can classify the object data accordingly.

At 320, the learning module 220 transforms the object data into partial data. In one embodiment, the learning module 220 breaks the object data down into various forms of partial data. That is, the learning module 220 uses the identified observations embodied within the object data to generate the partial data (i.e., data that represents a partial observation) by downgrading, reducing, sectioning, segmenting, occlusion-simulating, or otherwise transforming the object data such that the produced partial data includes fewer data points than the object data. Additionally, it should be appreciated, that while transforming the object data into partial data is discussed, in one embodiment, the object data itself already includes obscured data that has been identified. Thus, the object data may include data of previously identified partial observations. Consequently, the learning module 220 can produce training data instead of acquiring the data over time while the vehicle 100 is operating and/or use data that is collected and subsequently identified as the training data.

Moreover, while transforming the object data is discussed in relation to a single object, the learning module 220, in one embodiment, generates a plurality of different partial data models for each of a plurality of different objects. Accordingly, the learning module 220 populates a training data set in the database 240 with a plurality of partial observations by generating the partial observations from known objects. In this way, the learning module 220 can produce the training data set to include a comprehensive set of examples.

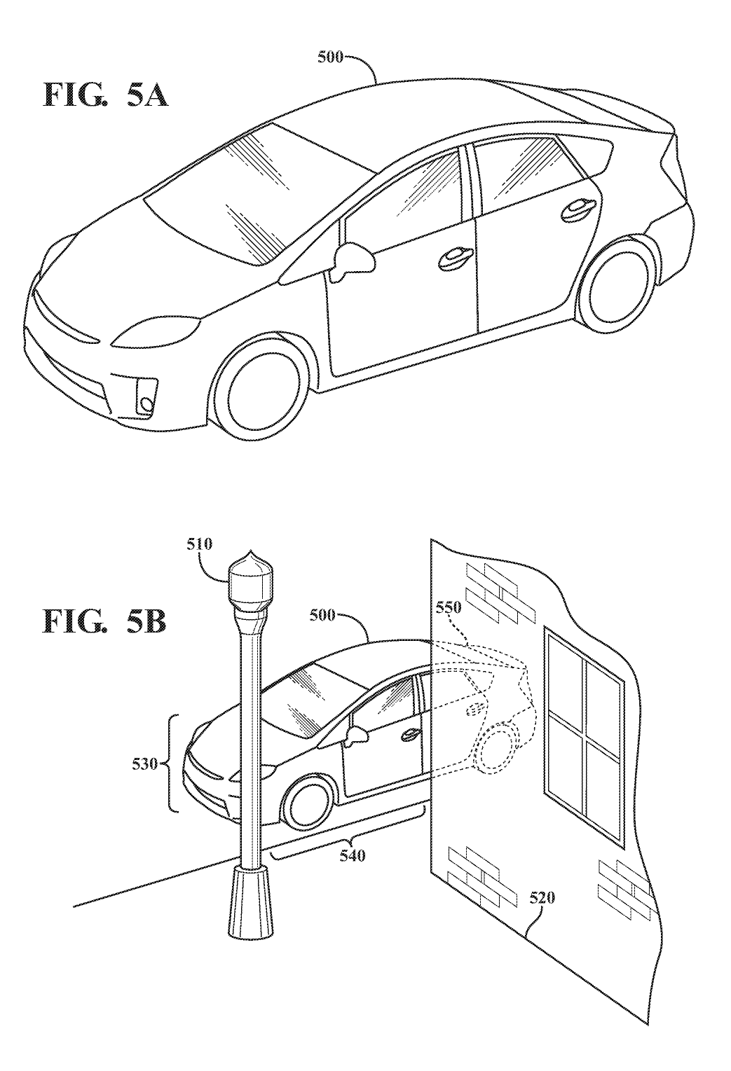

As one example of object data for a known object and obscured data/partial data, briefly, consider FIG. 5A and 5B. FIG. 5A illustrates a three-dimensional model 500 of a vehicle. The model 500 illustrated in FIG. 5A represents, for example, an optimal scenario of acquired data for an object. That is, the model 500 of FIG. 5A can be considered to be a generally comprehensive observation of the vehicle. Alternatively, in one embodiment, the model 500 is computer generated. In either case, the model 500 as depicted in FIG. 5B represents either obscured data of an object that is obscured by a light pole 510 and a building 520 or partial data as generated by the learning module 220 transforming the model 500. In either case, it should be appreciated that obscured data that is acquired by the LIDAR 124, and partial data that is generated by the learning module 220 are generally intended to be similar. Accordingly, whether the model 500 as illustrated in FIG. 5B is a result of the objects 510 and 520 occluding a portion 550 of the model 500 or whether the learning module 220 transforms the object data to block out the portion 550, the partial/obscured data represented in FIG. 5B includes fewer data points than the model represented in FIG. 5A.

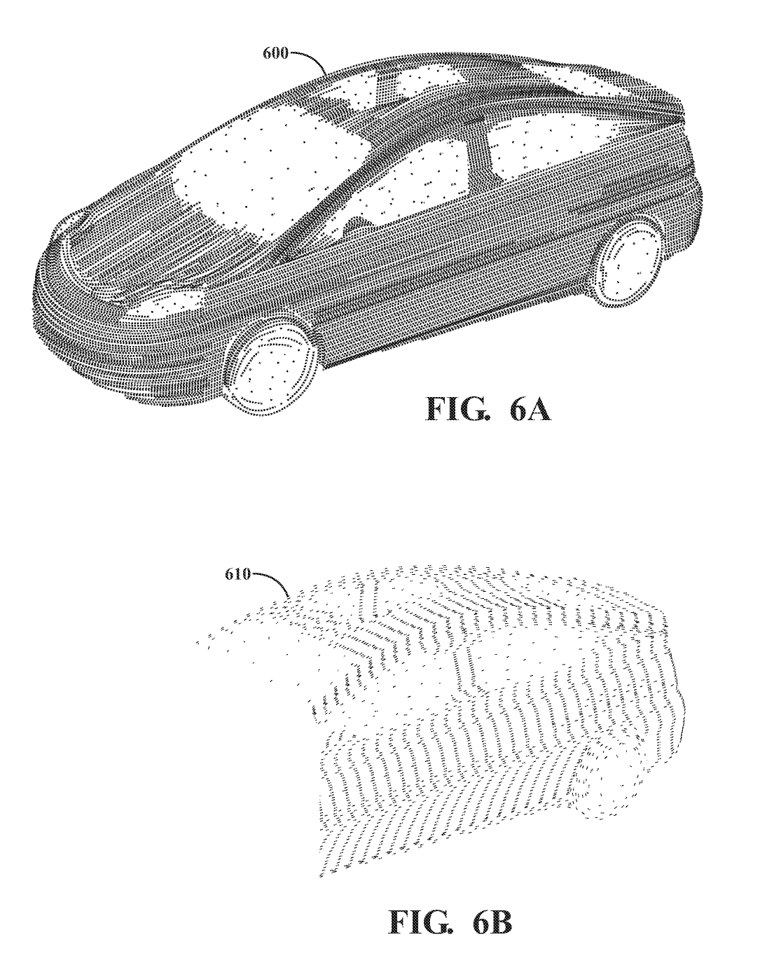

As another example, FIG. 6A and 6B illustrate point clouds of a same object but with differing resolutions and observed sections. That is, the point cloud 600 embodies a comprehensive observation of an associated vehicle from which the data of the point cloud 600 was acquired. By contrast, the point cloud 610 embodies a partial observation of the vehicle that is at (i) a reduced resolution in comparison to the point cloud 600 and (ii) is also missing a forward portion of the vehicle. Thus, the point cloud 610 is of lesser relative resolution than the point cloud 600. While the point cloud 610 is illustrated with both a reduction in resolution and missing sections, partial/obscured data may include one or both types of missing data.

Accordingly, the two point clouds 600 and 610 represent the distinctions discussed herein between a comprehensive observation of an object from which an identification may be simply made and a partial observation of an object that produces obscured data from which an estimating and/or identifying the object can be complicated. Thus, the learning module 220 can produce/simulate the point cloud 610 and similar point clouds as the partial data from the point cloud 600 when populating a training data set to train the observation model 250. Moreover, the point cloud 610 is similar to a partial observation of obscured data that can be acquired by the LIDAR sensor 124 when scanning an associated vehicle. Thus, the point cloud 610 represents either partial data produced by the learning module 220 or an actual partial observation of the LIDAR 124 of an obscured object.

Continuing with the method 300, at 330, the learning module 220 trains the observation model 250. In one embodiment, the learning module 220 uses the partial data from 320 that is a training data set to train the observation model 250. In general, the partial data is distinguished from actual partial observations simply in the sense that the partial data is labeled and/or otherwise classified/identified. Otherwise, the partial data is intended to represent partial observations that may actually occur. For example, as shown in FIG. 5B, the model 500 is blocked by additional objects 510 and 520. A resulting partial observation includes a front quarter 530 and a middle section 540 of the full model 500. The partial observation of FIG. 5B may also be recreated by the learning module 220 when generating partial data from the model 500.

Moreover, in one embodiment, the observed sections 530 and 540 may be further degraded in resolution by weather conditions, lighting conditions, and so on. It should be noted that the FIG. 5A and 5B are represented as line drawings for purposes of illustration but would generally be implemented as point clouds. Thus, changes in resolution are not shown in FIG. 5A or 5B.

In any event, the learning module 220 trains the observation model 250 so that when the LIDAR 124 acquires a partial observation of an object, the object may still be identified. In general, the learning module 220 implements one or more forms of machine/deep learning to achieve this functionality. Accordingly, the machine/deep learning implemented through the learning module 220 generally functions to identify relationships and/or patterns in the partial data using a complex network of analysis and, for example, accumulated probabilities over the training data set. Thus, in one embodiment, the learning module 220 implements a supervised learning algorithm (e.g., Naïve Bayes), an unsupervised learning algorithm, a reinforcement learning algorithm, a deep learning algorithm (e.g., deep convolutional/recurrent neural network) or an equivalent analysis. In this way, the learning module 220 provides the ability to estimate shapes/forms of objects by interpolating the missing sections using the provided observation model 250 when a comprehensive observation is not available.

At 340, the observation model 250 is stored. In one embodiment, the model 250 is stored in the database 240, or the memory 210 within the system 170. In an alternative embodiment, the model 250 is stored in a distributed/cloud-based memory and is accessed via a network connection.

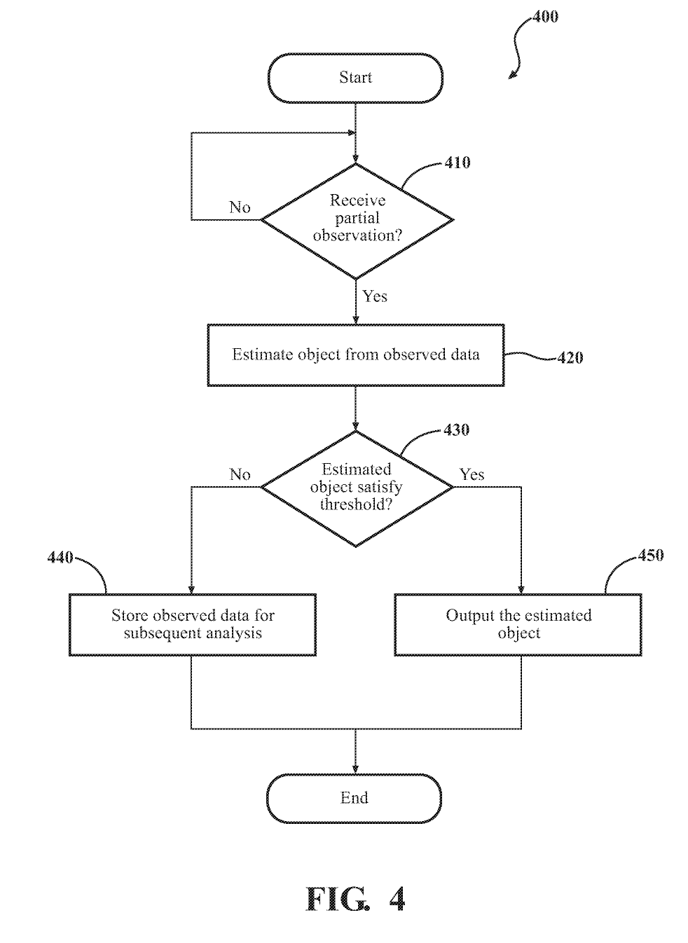

Further aspects of estimating objects from partial observations will be discussed in relation to FIG. 4. FIG. 4 illustrates a method 400 associated with estimating objects from obscured/partial observations. Method 400 will be discussed from the perspective of the observation system 170 of FIGS. 1 and 2. While method 400 is discussed in combination with the observation system 170, it should be appreciated that the method 400 is not limited to being implemented within the observation system 170, but is instead one example of a system that may implement the method 400.

At 410, the estimating module 230 receives observed data and determines whether the observed data is a partial observation of an observed object. In one embodiment, the estimating module 230 communicates with the LIDAR sensor 124 over a data bus or other communication channel to obtain data about a surrounding environment of the vehicle 100. Thus, the estimating module 230, in one embodiment, receives data points in the form of three-dimensional point clouds of surroundings of the vehicle 100. Thus, the estimating module 230 can perform an initial monitoring and assessment of the received data to determine whether various sections within the observed data potentially correlate with objects such as vehicles, pedestrians, etc. In one embodiment, the estimating module 230 also obtains electronic control signals from additional sensors (e.g., cameras) that are used to corroborate whether an object is within a particular locality. In either case, when the estimating module 230 determines, at 410, that data from the LIDAR 124 includes a partial observation, then the estimating module 230 proceeds with analyzing the observed data at 420. Alternatively, in one embodiment, the estimating module 230 can continuously analyze a data stream from the LIDAR 124, at 420, to detect a presence of potential objects proximate to the vehicle 100.

At 420, the estimating module 230 analyzes the observed data using the observation model 250. In one embodiment, the estimating module 230 uses the observation model 250 to interpolate one or more missing portions of an observed object so that the observed object can be reconstructed. In other words, the estimating module 230 uses the observed data that includes observations of parts of the observed object to fill-in the one or more missing sections using, for example, interpolation that is based, at least in part, on learned characteristics of objects embodied by the observation model 250. Accordingly, while the observation model 250 is discussed as being used to correlate the observed data with characteristics of the known objects, the estimating module 230, in one embodiment, undertakes a multi-tier analysis according to learned data and an implemented machine/deep learning algorithm in order to approximately reconstruct a whole body of the partially observed object. In this way, the estimating module 230 receives observed data that partially represents an object and uses the observed data to estimate missing sections of the observed object by interpolating missing data points and, thus, providing a reconstructed object.

At 430, the estimating module 230 determines whether the reconstructed observed object satisfies a threshold. In one embodiment, the estimating module 230 assesses the reconstructed observed object to determine how well the reconstructed object conforms with particular criteria. For example, the criteria can indicate object classes (e.g., vehicle, person, etc.) and attributes of those different classes. Thus, the estimating module 230 can undertake an analysis at 430 to determine how closely the reconstructed object conforms to the known classes, or, in one embodiment, a particular object within a class. The estimating module 230, in one embodiment, produces a score that is, for example, a probability that the reconstructed object conforms to the known class and/or particular object within the class. Accordingly, at 430, the estimating module 230 determines whether the provided probabilities/score satisfy a threshold (e.g., within a specified confidence interval such as 85% or greater). When the estimating module 230 determines that the score satisfies the threshold, the reconstructed object is considered to be, for example, highly complete and thus is a close approximation of a whole body of the observed object. Consequently, the estimating module 230 can then proceed to block 450 where a determination is provided as output (e.g., the reconstructed model is provided as a three-dimensional point cloud).

However, if the probability/score does not satisfy the threshold, then the partial observation is, for example, stored at 440 for subsequent analysis. That is, at 440, the estimating module 230 stores the observed data from the partial observation so that the observed data may be subsequently identified for additional training of the observation model 250 by the learning module 220.

At 450, as previously mentioned, the estimating module 230 provides an output of the observed object. In one embodiment, the estimating module 230 provides the reconstructed object that is the observed data in combination with interpolations of the one or more missing sections of the observed object. Thus, the reconstructed object is, in one embodiment, a three-dimensional point cloud that includes actual observation data of the observed object in combination with interpolated data points determined by using the observation model 250 to estimate the missing sections.

Consequently, the estimating module 230 can then use the reconstructed object to identify to object, for tracking of the object and for other purposes as though the object was originally observed to an extent that the additional functionality was operable. Thus, additional information about the observed object can be provided to, for example, an autonomous driving module 160 so that the observed object can be mapped and included within an obstacle map or another planning mechanism of the autonomous module 160. In one embodiment, the provided output is verified via an additional verification process (e.g., networked service) prior to being labeled and used by the vehicle 100. In one embodiment, the reconstructed object may also be stored in the memory 210, in the database 240, or in another suitable memory for further subsequent analysis similar to the storing discussed at 440.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact. Moreover, in one embodiment, the data store 115 is a distributed memory that is accessed through a communication channel such as a wireless network connection.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangement, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangement, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., the present context).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes and data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element or arrangement or groups thereof that enable information/data to be entered into a machine. The input system 130 can receive an input from a vehicle passenger (e.g. a driver or a passenger). The vehicle 100 can include an output system 135. An “output system” includes any device, component, or arrangement or groups thereof that enable information/data to be presented to a vehicle passenger (e.g. a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110, the observation system 170, and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110, the observation system 170, and/or the autonomous driving module(s) 160 may control some or all of these vehicle systems 140 and, thus, may be partially or fully autonomous.

The processor(s) 110, the observation system 170, and/or the autonomous driving module(s) 160 can be operatively connected to communicate with the various vehicle systems 140 and/or individual components thereof. For example, returning to FIG. 1, the processor(s) 110, the observation system 170, and/or the autonomous driving module(s) 160 can be in communication to send and/or receive information from the various vehicle systems 140 to control the movement, speed, maneuvering, heading, direction, etc. of the vehicle 100. The processor(s) 110, the observation system 170, and/or the autonomous driving module(s) 160 may control some or all of these vehicle systems 140.

The processor(s) 110, the observation system 170, and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110, the observation system 170, and/or the autonomous driving module(s) 160 can control the direction and/or speed of the vehicle 100. The processor(s) 110, the observation system 170, and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels).

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine/deep learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 either independently or in combination with the observation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. The autonomous driving module(s) 160 can be configured to execute various vehicle functions and/or to transmit data to, receive data from, interact with, and/or control the vehicle 100 or one or more systems thereof (e.g. one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-2, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, a distributed memory, a cloud-based memory, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An observation system of a vehicle, comprising:
one or more processors;
a memory communicably coupled to the one or more processors and storing:
a learning module including instructions that when executed by the one or more processors cause the one or more processors to electronically access, within a database, object data that is a three-dimensional representation of a known object,
transform the object data to produce partial data that is a partial representation of the known object with a relative fewer number of data points than the object data, and
train an observation model by using the partial data that is linked to the known object to represent relationships between the object data and the partial data that provide for estimating the known object from data of a partially observed object that is unknown.

2. The observation system of claim 1, further comprising:
an estimating module including instructions that when executed by the one or more processors cause the one or more processors to receive, from a sensor, observed data that is a partial observation of an observed object, and
estimate the observed object by analyzing the observed data according to the observation model to interpolate one or more missing sections of a body of the observed object using the observed data.

3. The observation system of claim 2, wherein the estimating module further includes instructions to interpolate the missing sections to reconstruct the body of the observed object as a function of the observed data and the relationships learned by the observation model and embodied within learned characteristics in the observation model, wherein the estimating module further include instructions to identify the observed object from the reconstructed body of the observed object.

4. The observation system of claim 1, wherein the learning module further includes instructions to transform the object data by segmenting the object data to produce the partial data as a section of the object data that is a less-than-whole representation of the known object.

5. The observation system of claim 1, wherein the learning module further includes instructions to train the observation model by applying a deep learning algorithm to the partial data for the known object to describe the relationships between the partial data and a body of the known object.

6. The observation system of claim 1, wherein the learning module further includes instructions to transform the object data by downgrading the object data to produce the partial data with fewer data points and a reduced resolution in comparison to the object data.

7. The observation system of claim 1, wherein the learning module further includes instructions to train the observation model by identifying the relationships for each of a plurality of versions of the known object, wherein the learning module and the observation model form a deep learning network.

8. The observation system of claim 1, wherein the object data is a three-dimensional point cloud from a light detection and ranging (LIDAR) sensor.

9. A non-transitory computer-readable medium storing instructions that when executed by one or more processors cause the one or more processors to:
receive, from a sensor, observed data that is a partial observation of an observed object, wherein the observed data is missing one or more sections of a body of the observed object, and
estimate the observed object by interpolating the one or more missing sections of the body of observed object according to an observation model and the observed data.

10. The non-transitory computer-readable medium of claim 9, further comprising instructions to:
retrieve, from a database, object data that is a three-dimensional representation of a known object,
transform the object data to produce partial data that is a partial representation of the known object with a relative fewer number of data points than the object data, and
train the observation model by using the partial data that corresponds to the known object to describe relationships between the object data and the partial data that provide for estimating the known object from data of a partially observed object that is unknown.

11. The non-transitory computer-readable medium of claim 10, wherein the instructions to transform the object data include instructions to downgrade the object data to produce the partial data with fewer data points and a reduced resolution in comparison to the object data.

12. The non-transitory computer-readable medium of claim 10, wherein the instructions to transform the object data include instructions to segment the object data to produce the partial data as a section of the object data that is a less-than-whole representation of the known object, and wherein the instructions to train the observation model include instructions to apply a deep learning algorithm to the partial data for the known object to determine the relationships that identify the partial data as corresponding to the known object.

13. The non-transitory computer-readable medium of claim 9, wherein the instructions to estimate the one or more missing sections by interpolating include instructions to reconstruct the body of the observed object and to identify the observed object from the body that has been reconstructed.

14. A method of estimating objects from obscured data, comprising:
accessing, from a database, object data that is a three-dimensional representation of a known object;
transforming the object data to produce partial data that is a partial representation of the known object with a relative fewer number of data points than the object data; and
training an observation model by using the partial data that is linked to the known object to represent relationships between the object data and the partial data that provide for estimating the known object from the obscured data of a partially observed object that is unknown.

15. The method of claim 14, further comprising:
receiving, from a sensor, observed data that is a partial observation of an observed object; and
estimating the observed object by analyzing the observed data according to the observation model to interpolate one or more missing sections of a body of the observed object.

16. The method of claim 15, wherein interpolating the missing sections includes reconstructing the body of the observed object as a function of the observed data and the relationships learned by the observation model and embodied within learned characteristics in the observation model, and
wherein estimating the observed object includes identifying the observed object from the reconstructed body.

17. The method of claim 14, wherein transforming the object data includes segmenting the object data to produce the partial data as a section of the object data that is a less-than-whole representation of the known object.

18. The method of claim 14, wherein training the observation model includes applying a deep learning algorithm to the partial data for the known object to describe the relationships between the partial data and a body of the known object.

19. The method of claim 14, wherein transforming the object data includes downgrading the object data to produce the partial data with fewer data points and a reduced resolution in comparison to the object data, wherein transforming the object data includes generating a plurality of versions of the partial data, and wherein training the observation model includes identifying the relationships for each of the plurality of versions to train the observation model for different partial observations of the known object.

20. The method of claim 14, wherein the object data is a three-dimensional point cloud from a light detection and ranging (LIDAR) sensor, and wherein the observation model is a deep learning network.
